(19) United States
(12) Patent Application Publication
(10) Pub. No.: US 2007/0162239 A1
(43) Pub. Date: Jul. 12, 2007

(54) Determination of the transit time difference in an ultrasonic flow sensor with multiple zero crossing detection

(76) Inventor: Tobias Lang, Stuttgart (DE)

Correspondence Address: Striker Striker & Stenby, 103 East Neck Road, Huntington, NY, 11743, US

(21) Appl. No.: 10/587,685

(22) PCT Filed: Jan. 19, 2005
(86) PCT No.: PCT/EP05/50208

§ 371 Date: Jul. 27, 2006

(30) Foreign Application Priority Data
Mar. 18, 2004 (DE) 102004013249.6

(51) Int. Cl. G01F 1/66

(52) U.S. Cl. 702/54; 702/1; 702/50; 73/170.01; 73/170.13

(57) ABSTRACT

The invention relates to an ultrasonic flow sensor, particularly for measuring a volume flow or mass flow of a fluid (1), which includes two ultrasonic converters (A,B) that are offset in the direction of flow (2) and each transmit a periodic ultrasonic signal (S1,S2) to the other ultrasonic converter (B,A), and a control and evaluation unit (4) that detects several reception times (tᵢ′,tᵢ″) per ultrasonic signal (S1,S2) when an ultrasonic signal (S1,S2) is received by an ultrasonic converter (B,A), a measured quantity (S) being determined from one of the reception times (tᵢ′,tᵢ″). The accuracy of the measurement can be improved substantially when the control and evaluation unit (4) includes at least two counters (5a,5b), the first counter counting a period (Δt′) from a first switchover/reception time (t₁′) of a signal (S2,P) at least until the first reception time (t₁″) of the ultrasonic signal (S1), and the second counter determining the time interval (Δt″) between a first instant and a second instant out of several paired instants (tᵢ′,tᵢ″) of the signals (S1,S2,P).

The present invention relates to an ultrasonic flow sensor according to the preamble of claim 1, and a method for evaluating the ultrasonic signals with an ultrasonic flow sensor of this type according to the preamble of claim 9.

Ultrasonic flow sensors are used, in particular, to measure the volume flow, mass flow, or the flow rate of a gaseous or liquid medium that flows through a pipeline. A known type of ultrasonic flow sensor includes two ultrasonic converters located such that they are offset in the direction of flow, each of which generates ultrasonic signals and transmits them to the other ultrasonic converter. The ultrasonic signals are received by the other converter and are evaluated using electronics. The transit time difference between the ultrasonic signal in the direction of flow and the ultrasonic signal in the opposite direction is a measure of the flow rate. Based thereon, the desired measured quantity, e.g., a volumetric flow rate, can be calculated.

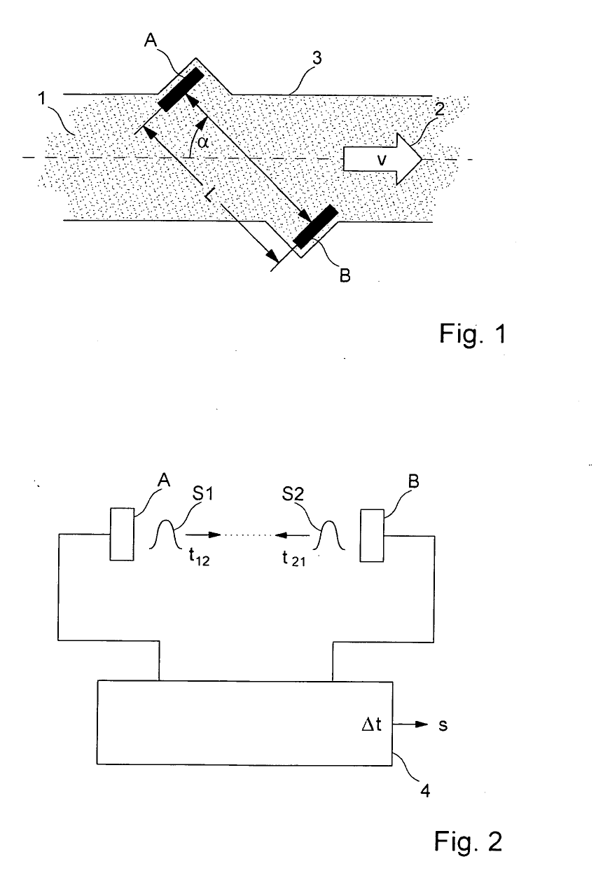

FIG. 1 shows a typical design of an ultrasonic flow sensor with two ultrasonic converters A,B, which are located inside a pipeline 3 and are diametrically opposed at a distance L from each other. A fluid 1 flows in pipeline 3 with a velocity v in the direction of arrow 2.Measurement path L is tilted relative to flow direction 2 at an angle α. During a measurement, ultrasonic converters A,B send ultrasonic pulses to each other that are slowed or accelerated, depending on the direction of the flow. The signal transit times are a measure of the flow rate to be determined.

FIG. 2 shows a greatly simplified, schematic depiction of a converter system with control and evaluation electronics 4 connected thereto. The sensor works according to the sing-around method. According to this method, when an ultrasonic signal S1 or S2 is received by one of the converters A,B, an ultrasonic signal is immediately sent out in the opposite direction.

A flow measurement takes place essentially as follows: Electronics 4 emits an electrical pulse to a converter A which, in response, generates an ultrasonic signal S1 and transmits it to second converter B. After a path transit time t₁₂, signal S1 is received by second converter B. Second converter B immediately generates an ultrasonic signal S2, which arrives at first converter A after a path transit time t₂₁. If t₁₂ and t₂₁ are the sound transit times of the signals from A to B and vice versa, this results in a transit time difference of Δt=t₁₂−t₂₁. The flow rate v can then be calculated as follows:

$$v = \frac{2 L}{cos α} \cdot \frac{Δ t}{{( \sum t )}^{2}} \cdot \frac{1}{s}$$

$$\underline{v = ( \frac{1}{{t}_{12}} - \frac{1}{{t}_{21}} ) \cdot \frac{L}{2 cos α}}$$

In this formula, Σt=t₁₂+t₂₁, or the total transit time for a cycle or cycle time, and s is a correction factor, with s=1−(Δt/Σt)2.

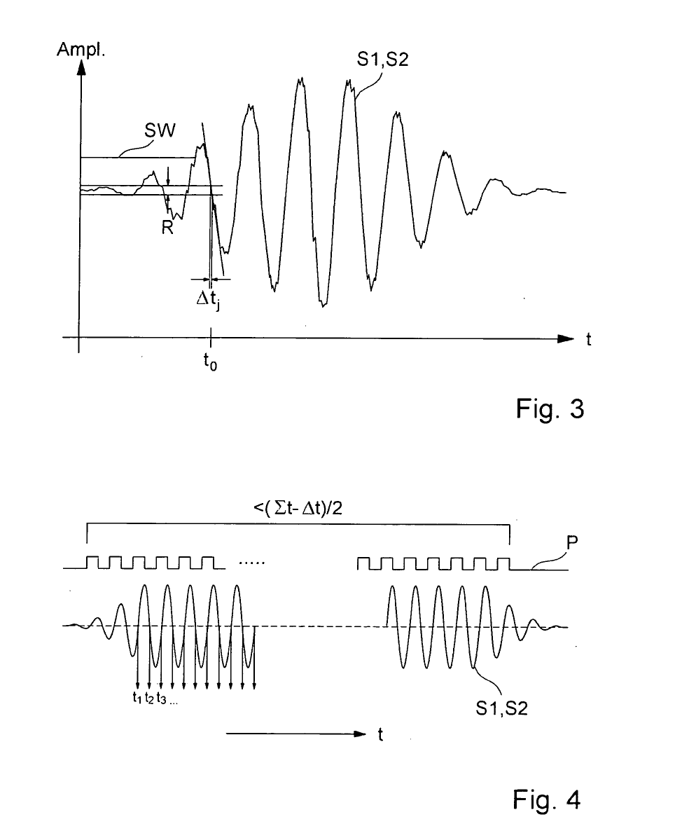

FIG. 3 shows the graph of a single ultrasonic signal S1,S2 over time, and the manner in which a reception time is determined with a signal of this type. This is a depiction of zero crossing detection. The “reception time” of the signal is defined as the first zero crossing of the signal, after the amplitude has exceeded a specified threshold value SW (the “pretrigger level”). In this example, the reception time would therefore be time t₀.

Due to the noise component R that is superimposed on the signal, zero crossing detection results in a relatively high level of temporal inaccuracy Δtⱼ in pulse edge detection. Normally, inaccuracy Δtⱼ is so great that usable measurement accuracy cannot be attained in a single measurement, particularly at low flow rates.

To increase the measurement accuracy, it is therefore preferable to generate a longitudinal ultrasonic signal at the ultrasonic converters, as shown in FIG. 4. When a signal S1,S2 of this type is received by the other converter, several reception times per ultrasonic signal are detected. A measurement therefore provides several bits of transit time information, based on which a measured value can be determined with great accuracy, whereby the measurement is carried out much more quickly than are several individual measurements.

FIG. 4 shows signals P, S1,S2 in an enlarged depiction, exciting signal P being shown at the top, and ultrasonic signal S1 or S2 produced therewith being shown at the botton of the figure. As shown, the frequency of ultrasonic signal A1,B1 corresponds to that of exciting signal P. Ultrasonic signal A1,B1 also has a maximum amplitude that remains essentially the same over several periods.

In terms of detecting signals S1,S2, control and evaluation circuit 4 is realized, e.g., such that a reception time t₁−tn is detected at every zero crossing of an ultrasonic signal S1 or S2 (after the amplitude of the signal has exceeded a specified threshold SW).

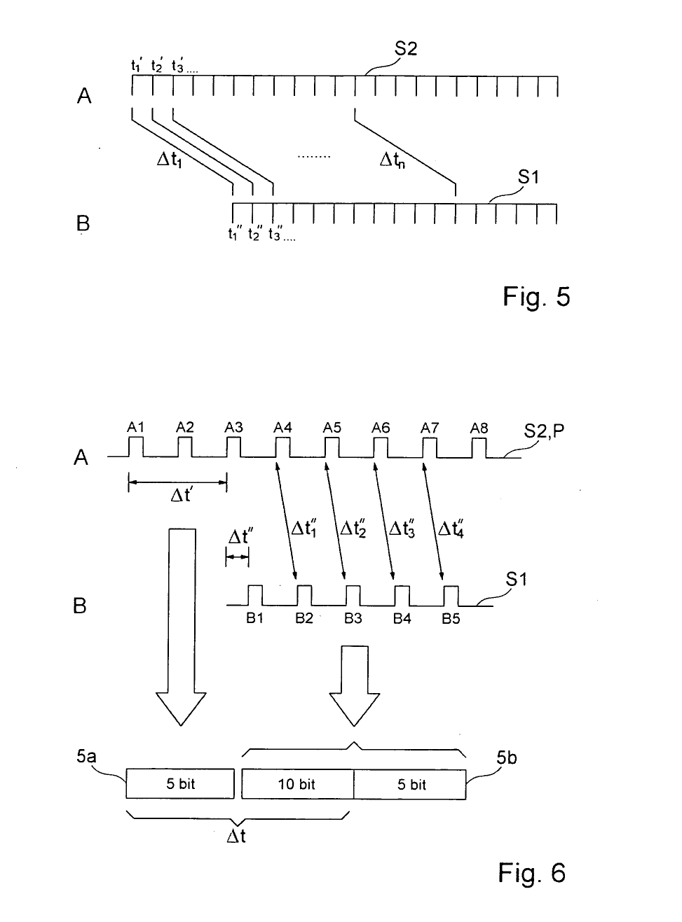

FIG. 5 shows the reception times of signals S1,S2 in the order of their arrival at ultraonic converters A,B. In this example, signal S2 arrives at converter A several signal periods earlier than signal S1 arrives at converter B. The related reception times t₁′, t₁″. . . tₙ′, tₙ″ are used to calculate a transit time difference Δt₁ . . . . Δtₙ. Typically, n counters are required for this, with which the transit time differences Δtᵢ of related reception events are counted. This is relatively expensive and complicated.

The object of the present invention, therefore, is to create an ultrasonic flow sensor and a corresponding method with which the transit times of two longitudinal ultrasonic signals can be determined with the least amount of technical outlay. It should also be possible to determine the transit times under unfavorable flow conditions or when the flow direction changes.

This object is attained according to the present invention by the features indicated in claim 1 and in claim 9. Further embodiments of the invention are the subject of dependent claims.

An essential aspect of the present invention is to provide a control and evaluation unit with two counters, the first counter counting the number of full intervals of a first signal (e.g., of a reference signal or a first ultrasonic signal) at least until the first reception time of an ultrasonic signal, and the second counter counting the particular period between a first and second switchover/reception time of the two signals, the switchover/reception times being grouped in pairs. Due to the fact that the transit time or transit time difference of the ultrasonic signals is determined from several periods that do not temporally overlap, the transit time or transit time difference can be determined using just two counters and, therefore, with a very small amount of technical outlay.

An ultrasonic flow sensor that functions according to the measurement principle described above can be operated in various manners. A first possibility is to simultaneously transmit one ultrasonic signal to each of the two ultrasonic converters and to measure the transit time difference between the ultrasonic signals using the two counters. A second possibility is to initially transmit an ultrasonic signal to just one of the converters and measure its transit time with consideration for a clock pulse, and to subsequently repeat the same transit time measurement at the other converter.

The operating mode of the flow sensor with which the ultrasonic signals are transmitted simultaneously by the converters will be described initially below. In this case, the first counter counts the number of full intervals (defined by two consecutive reception times) of the ultrasonic signal that arrives first, at least until the first reception time of the subsequently arriving ultrasonic signal, and the second counter counts the period between a first reception time and a second reception time out of several paired reception times of different ultrasonic signals.

The paired reception times (reception pairs), the period of which is measured by the second counter, preferably include a reception time of one ultrasonic signal and an immediately following reception time of the other ultrasonic signal. The reception pairs are preferably selected such that they follow each other directly, without any individual reception times being left out. The evaluation and control unit preferably calculates a mean of the measured intervals between the reception pairs. It is therefore possible to determine a relatively accurate value for the transit time difference of the ultrasonic signals out of the counter status of the first counter and the averaged counter status of the second counter.

According to a preferred embodiment of the present invention, two particular reception times are paired according to the following rule: The control and evaluation unit initially checks to determine whether the first reception time of the subsequently arriving signal is temporally closer to the previous or subsequent reception time of the initially arriving ultrasonic signal than a specified time threshold, the first counter determining—in the first case—the period (or the number of full intervals) from the first reception time of the first signal to the reception time of the first signal that precedes the first reception time of the subsequently arriving ultrasonic signal and, in the other case, it counts until the reception time of the first ultrasonic signal that follows the first reception time of the subsequently arriving ultrasonic signal. The first counter therefore counts the number of full intervals of the first ultrasonic signal until the first reception time of the subsequently arriving ultrasonic instant or one more interval, depending on the position of the first reception time of the subsequently arriving ultrasonic signal in the interval of the first ultrasonic signal.

The second counter preferably counts the periods between two consecutive reception times of different signals. (The sequence of the reception times used to define a reception pair can change during the measurement due to signal shift).

In the first case, the transit time difference is calculated based on the counter status of the first counter and a mean of the counter status of the second counter using addition. In the second case, it is calculated using subtraction, and the different weight of the two counters is taken into account. The fact that the selection of the first reception pair differs depending on the relative position of the first reception time of the subsequently arriving ultrasonic signal has the principal advantage that the evaluation is very robust to signal jitter (noise or signal chatter) or turbulent flow. The error rate is therefore reduced substantially.

The second counter is preferably designed as an up-down counter that changes the counting direction depending on the sequence of the paired reception times, and counts either up or down. In this manner, shifts, in particular, in the longitudinal ultrasonic signals resulting, e.g., from turbulent flow, can be taken into account.

Preferably, an explicit addition or subtraction of both counter statuses can be eliminated by also realizing the first counter as an up-down counter that receives a carry-over in the positive or negative direction from the second counter when the counter limits of the second counter are exceeded.

According to a preferred embodiment of the present invention, the second counter accumulates the periods of p pairs of reception times, p being a square number. The mean of the counter status of the second counter results by dividing by p. If p was selected to be a square number, the mean can be calculated easily by performing a shift register operation in which the decimal place is shifted by log₂p places.

The operating mode of the flow sensor with which the ultrasonic signals are transmitted in succession and the signal transit times are determined with consideration for a reference signal will be described below. As with the first operating mode, a longitudinal ultrasonic signal is generated using a clock pulse (exciting signal). This clock pulse itself can serve as a reference signal. As an alternative, the reference signal can be derived from the clock pulse by producing a voltage pulse with a defined edge (e.g., positive) with the positive and negative edges of the clock pulse. The ultrasonic signal is initially transmitted by only one of the converters and is received by the other converter.

The first counter then counts the number of full intervals of the reference signal at least until the first reception time of the arriving ultrasonic signal, and the second counter counts the period between a first reception time and a second reception time out of several paired reception times of the signals. The first counter therefore counts the number of full clock periods, and the second counter counts the time remaining until the ultrasonic signal arrives, with-consideration for several pairs of clock edge reception times (reception pairs). The result of this measurement is the transit time of the ultrasonic signal in one direction. The transit time of an ultrasonic signal is subsequently measured in the other direction, and the desired measured quantity is calculated based on the two transit times.

The embodiments described above in terms of the first operating mode also apply in a corresponding manner for the second operating mode.

When a reception event (e.g., a zero crossing) of an ultrasonic signal is detected, a digital signal is usually set in the evaluation circuit (e.g., from low to high) that displays the exact reception time of the reception event. The edge of this signal has a temporal inaccuracy titter). When the signal is sampled, aliasing effects occur when the clock rate of the sampling signal was not selected adequately high (Nyquist criterium). According to the present invention it is provided to sample the electrical signal at a sampling rate that is markedly higher than the reciprocal of the temporal inaccuracy of a reception event. As a result, the accuracy of the flow measurement can be increased substantially.

The present invention is explained below in greater detail with reference to the attached drawing as an example.

FIG. 1 hows a typical example of an ultrasonic flow sensor with two ultrasonic converters according to the related art;

FIG. 2 hows an ultrasonic flow sensor with an associated control and evaluation circuit;

FIG. 3 hows a typical ultrasonic signal according to the related art, and it shows the detection of the reception time;

FIG. 4 hows a longitudinal ultrasonic signal with several zero crossings that are used to measure time;

FIG. 5 hows the determination of n transit time differences using n counters;

FIG. 6 hows the determination of the transit time difference of the ultrasonic signals using two counters according to a first embodiment of the present invention;

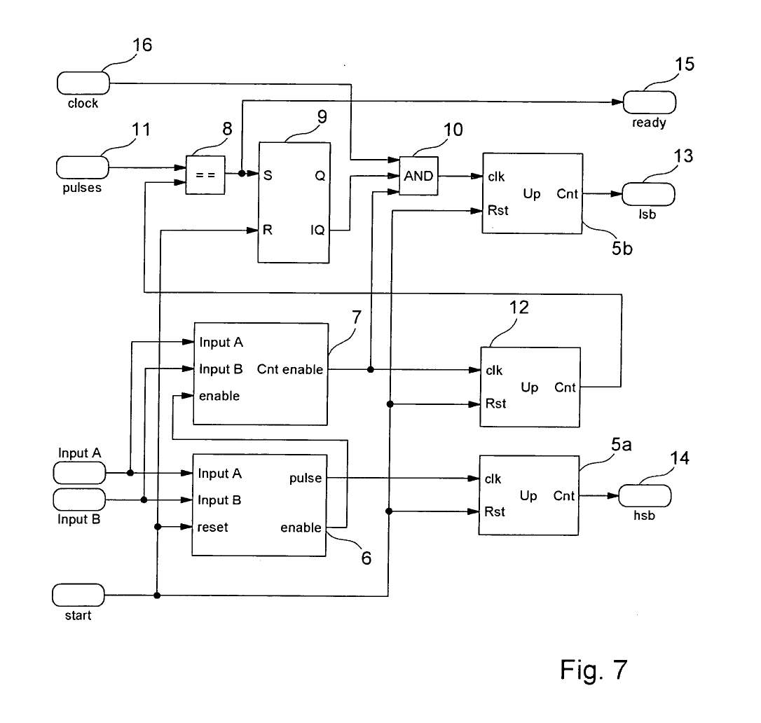

FIG. 7 hows a control and evaluation circuit for the determination of the transit time difference according to FIG. 6;

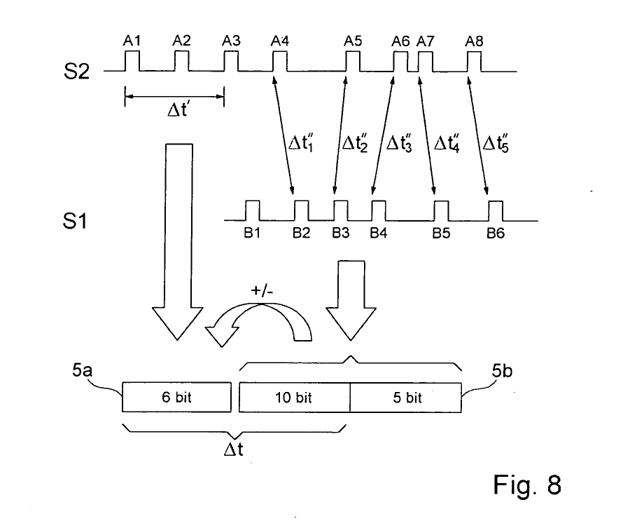

FIG. 8 hows the determination of the transit time difference between two ultrasonic signals according to another embodiment of the present invention;

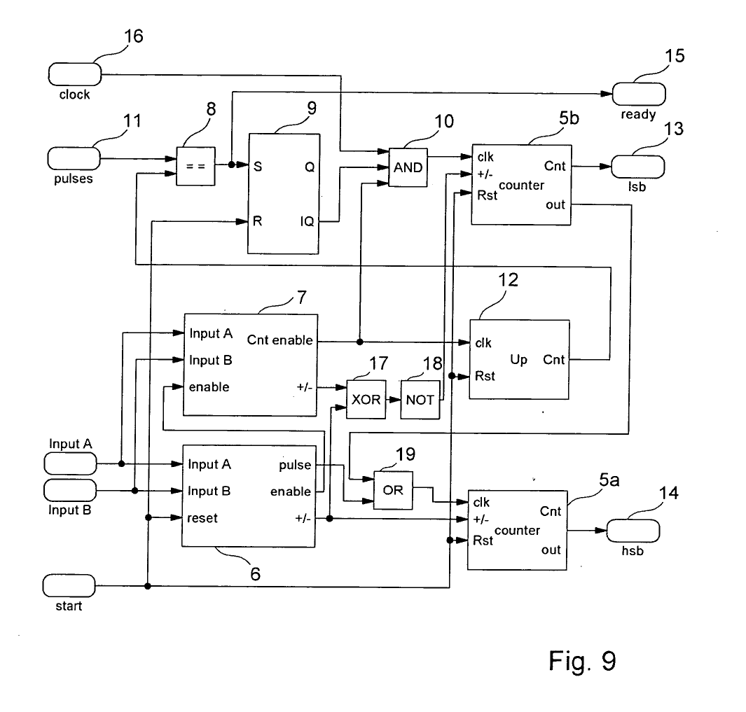

FIG. 9 shows a control and evaluation unit for the determination of the transit time difference between two ultrasonic signals according to the method in FIG. 8;

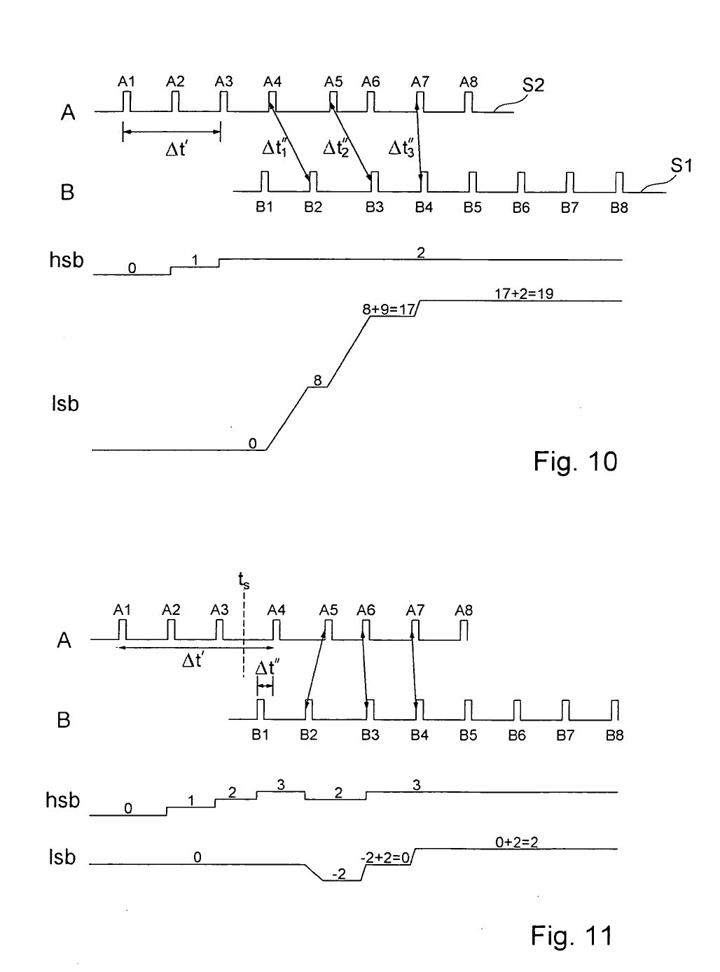

FIG. 10 shows an example of a faulty evaluation of the transit time difference when reception times shift;

FIG. 11 shows the evaluation of the transit time difference with two uneven ultrasonic signals according to a preferred embodiment of the present invention;

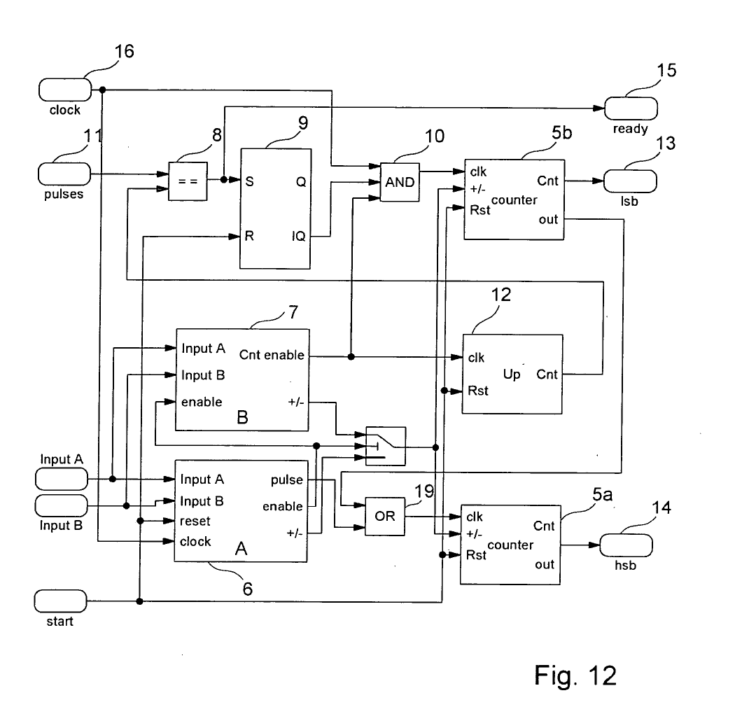

FIG. 12 shows a control and evaluation circuit for the determination of the transit time difference between two ultrasonic signals according to the method in FIG. 11;

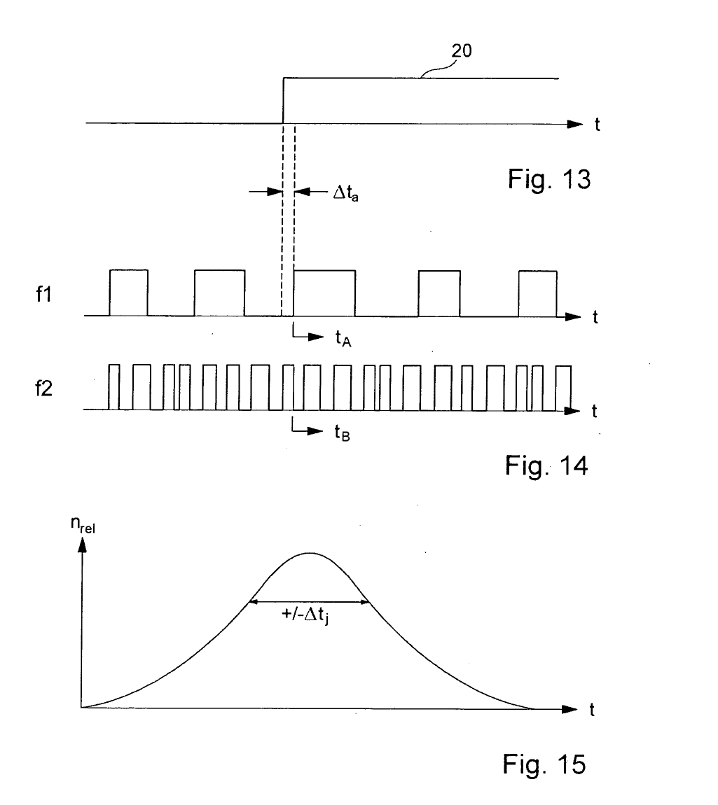

FIG. 13 shows a schematic representation of a single reception event;

FIG. 14 shows a sampled signal with a low and high frequency; and

FIG. 15 shows the normal distribution of the temporal inaccuracy in the detection of individual reception events.

FIGS. 1 through 5 are explained in the introduction of the description.

FIG. 6 shows an example of the course over time of ultrasonic signals S1,S2 that were received by ultrasonic converters A, B and were simultaneously sent out to the other converter B,A. The positive edges of digital pulses A1-An and B1-Bn each represent the receipt of a zero crossing of ultrasonic signals S1 and S2 at instants tᵢ′ and tᵢ″. The transit time difference Δt between the two ultrasonic signals S1,S2 is equal to the period from pulse A1 to pulse B1.

The transit time difference can be expressed as a period Δt′ from pulse A1 to A3 plus a remaining value Δt″ between pulses A3 and B1, where Δt=Δt′+Δt″. To reduce the statistical measurement error, as many zero crossings of signals S1,S2 as possible are taken into account, and several remaining periods Δt″ are measured and subsequently averaged. Transit time difference At between ultrasonic signals S1,S2 therefore results from the value of Δt′ and the mean of times Δtᵢ″.

The duration of times Δt′ and Δtᵢ″ can be easily measured using two counters 5a,5b. First counter 5a counts the duration of the full intervals (one interval corresponds to the time between two consecutive pulses, e.g., A1,A2, of the same ultrasonic signal) until first pulse B1 of subsequently arriving ultrasonic signal S1 arrives. The counter status of first counter 5a is a rough estimate of the transit time difference Δt between the two ultrasonic signals S1,S2.

A second counter continually measures the periods Δtᵢ″ between two paired pulses A4,B2; A5,B3; etc., and therefore simultaneously sums the measured values. Pulse pairs are selected that are in immediate succession. The final counter value is averaged, and the mean is added to the counter status of first counter 5a. When digital counter 5a, 5b is used, the counter status of first counter 5a preferably represents the high-order bits (hsb: high significant bits) and the counter status of the second counter represents the low-order bits (lsb: least significant bits).Given the two prerequisites that the bit widths of first counter 5a and second counter 5b are matched correctly and that the ultrasonic frequency was generated by dividing by a square of the clock speed of the lsb counter, the lsb bits of the second counter can be attached directly to the hsb bits of the first counter and they can be combined to form a single binary number that is proportional to transit time difference Δt.

The counter status of second counter 5b can also be averaged in a particularly simple manner when a total of p measurements of p intervals Δtᵢ″ is carried out, and the number p is a square. In this case, the averaging of the binary counter value (division by p) is equal to a shift register operation by log₂p, with which the decimal place is moved log₂p places to the left. In the example shown in FIG. 6, p=2⁵=32 measurements of Δtᵢ″ are carried out, so the decimal place is moved 5 bits to the left. The final transit time difference At therefore results from the counter status of first counter 5a and the high-order bits (10 bits in this case) of second counter 5b in units of the oscillation period of the lsb clock speed, the 5 low-order bits of the second counter representing the same number of places to the right of the decimal point.

As an alternative to the depiction shown in FIG. 6, transit time difference Δt between signals S1,S2 could also be depicted as the difference between periods [A1 through A4] and [B1 through A4]. First counter 5a would have to count one interval further past the point when first pulse B1 arrived, i.e., it would have to count from A1 to A4, and second counter 5b would have to count the intervals between B2,A5; B3,A6; etc. The following applies: Δt=t[A1, A4]−t[B1, A4].

The same principles that were described with reference to FIGS. 6 through 15 apply in a second operating mode of the ultrasonic flow sensor, in which ultrasonic signals S1,S2 are not sent out simultaneously, but rather in succession. In this case, transit time Δt of an ultrasonic signal (e.g., S1) is initially measured in one direction and, subsequently, transit time Δt of an ultrasonic signal (e.g., S2) is measured in the opposite direction, with consideration for a reference signal (P). In FIGS. 6, 8, 10 or 11, signal S2 would be viewed as reference signal P that was derived from the same clock pulse with which longitudinal ultrasonic signal S1 was generated; in this case, reception times A1 would be switching times (e.g., positive edges) of reference signal P. (A separate depiction was therefore not provided).

As in the first operating mode, first counter 5a counts the number of full intervals of reference signal P at least until the first reception time Bi of arriving ultrasonic signal S1, and second counter 5b measures period Δtᵢ″ between a first switchover/reception time and a second switchover/reception time out of several switchover/reception times Ai,Bi of signals P, S1. The first counter therefore counts the number of full periods of the reference signal, and the second counter counts the time remaining Δtᵢ″ until the ultrasonic signal arrives. The result of this measurement is transit time Δt of ultrasonic signal S1. The transit time of ultrasonic signal S2 is subsequently measured in the other direction, and the desired measured quantity is calculated based on the two transit times Δt.

FIG. 7 shows an exemplary embodiment of a control and evaluation circuit 4 with two digital counters 5a, 5b for determining transit time difference Δt. The circuit has input A for signal S2 and input B for signal S1. Circuit module 6 receives pulses Ai and Bi from converters A,B at “Input A” and “Input B”, allows the initially arriving pulses (A1-A3 in this case)—except for the first pulse—to pass through (i.e., A2-A3 in this case) and forwards them to first counter 5a until “Input B” of the first pulse (B1 in this case) of subsequently arriving ultrasonic signal S1 arrives at the other input, “Input B”. The first counter therefore counts up to 2 (two full intervals), then it stops counting. Counter status hsb of first counter 5a is labeled with reference numeral 14. The counting rate of first counter 5a corresponds to the frequency of ultrasonic signals S1,S2.

After first pulse B1 of signal S1 arrives, module 6 activates a second module 7 using an “enable” signal. Second module 7 also receives pulses Ai,Bi at “Input A” and “Input B”, respectively, and activates second counter 5b during periods A4 B2; A5,B3, etc. (The output “Cnt enable” then becomes high). The output “cnt enable” is connected with an AND gate 10, the output of which is connected with clock input Clk of second counter 5b. Second counter 5b therefore counts upward with the “clock” clock rate applied to input 16 for as long as the output “cnt enable” of second module 7 is high and the number of measured intervals Δtᵢ″ is less than a specified number of intervals Δtᵢ″ that can be specified at input 11. The number of intervals Δtᵢ″ already measured is counted by counter 12, which is connected with the output “cnt enable” of second module 7. The inverted output of a flip flop 9 remains high until the number of intervals Δtᵢ″ measured is equal to the number of intervals specified at input 11. The equality of the number is recognized by a logic gate 8 that sets flip flop 9. Inverted output IQ therefore enters the low state, and second counter 5b stops counting. Finally, counter status lsb of second counter 5b is read out at output 13 and can be averaged as described above using a shift register operation. The circuit is reset via the “start” input, so that a new measurement can begin.

Provided the measurement is carried out according to the second operating mode described above, modules 6,7 receive reference signal P at “Input A” instead of converter output signal S2. Otherwise, circuit in FIG. 7 functions in the same manner as it does in the first operating mode.

FIG. 8 shows two ultrasonic signals S1,S2 received by converters A, B, reception times A1-A8 and B1-B6, respectively, of which move in opposite directions relative to each other over the course of signals S1,S2. A signal shift of this type can be induced, in particular, by turbulent flow conditions that are caused by a signal jitter (temporal noise or chatter) in signal S1,S2. As a result, the order of individual pulses A1-A8 can 5 also become reversed as compared with pulses B1-B6. When intervals Δtᵢ″ are evaluated according to the method depicted in FIG. 6, second counter 5b would evaluate intervals A4,B2; A5,B4; A6,B5, etc. and, therefore, incorrect intervals, which would result in a considerable measurement error.

According to the method depicted in FIG. 8, it is therefore provided that pulses Ai of lo first signal S2 be combined in pairs with pulses Bi of second signal SI, so that a pulse pair is formed out of two consecutive pulses Ai,Bi of different signals, and a sign (±) is assigned to each pulse pair A4,B2; B3,A5; etc. in accordance with the order in which the two pulses Ai,Bi arrive. Second counter 5b is subsequently counted up or down, depending on this sign (±), during the associated period Δtᵢ″ of a pulse pair Ai,Bi. The individual counter values for times Δtᵢ″ are preferably accumulated by second counter 5b. If the counter status of second counter 5b exceeds the counter limits of counter 5b (either 0 or the maximum counter status given by the bit width of the counter), a carry-over to first counter 5a occurs, i.e., first counter 5a is counted up or down by one.

After p time intervals Δtᵢ″ are evaluated, counter status lsb of second counter 5b is averaged. If p is a square number, the counter statuses of hsb counter 5a and lsb counter 5b can be easily combined into a single binary number without a further arithmetic operation, as depicted in FIG. 8, below, the binary number being proportional to the transit time difference or the flow rate.

FIG. 9 shows an embodiment of an evaluation unit 4 for carrying out the method described above with reference to FIG. 8. To ensure simplicity, neither the generation of ultrasonic signals S1,S2 from the clock pulse of a quartz oscillator nor the sequential control of the entire measurement procedure are shown.

The principal parts of the evaluation circuit are identical to those of evaluation circuit in FIG. 7, reference to which is hereby made. Electrical pulses Ai,Bi produced by converters A,B are fed to “Input A” and “Input B” of modules 6 und 7. Circuit module 7 allows the initially arriving pulses—except for the very first one—(A2-A3 in this case) to pass, and forwards signals to first counter 5a until first pulse B1 of other ultrasonic signal S1 arrives. The counting direction of first counter 5a is specified by module 6 via output ±. (The counting direction is positive or negative depending on which signal S1,S2 arrived first).

Module 7 also recognizes the order of pulses Ai,Bi in a pulse pair Ai,Bi and outputs either a positive or negative sign at the ± output accordingly and individually for each pulse pair. The sign is directed via an XOR member 17 and a NOT member 18 to second counter 5b, which counts up or down accordingly. As described with reference to FIG. 7, the “clock” pulse at input 16 arrives at second counter 5b only during time interval Δtᵢ″ via AND gate 10. The “clock” pulse is released during time interval Δtᵢ″ by module 7 at the “Cnt enable” output and therefore reaches second counter 5b.

FIG. 10 shows two ultrasonic signals S2 and S1 arriving in succession at ultrasonic converters A and B, the zero crossings of which do not arrive evenly at converters A,B, but which are instead displaced relative to each other. In terms of time, pulses A1-A8 and B1-B8 arrive at ultrasonic converters A,B such that intervals Δtᵢ″ of pulse pairs A5,B3 and A6,B4 overlap in terms of time. Temporally overlapping intervals Δtᵢ″ cannot be counted by a single counter, however. An evaluation error therefore occurs, as indicated by counter statuses hsb and lsb of first counter 5a and second counter 5b.

As usual, first counter 5a counts the number of full intervals (from A1-A3) of initially arriving signal S2 until first pulse B1 arrives, then it stops counting. The final counter status of first counter 5a is therefore hsb=2. Second counter 5b then counts, e.g., 8 counters during interval A4,B2, and it counts a further 9 counters up during interval A5,B3, skips pulse A6, then counts 2 more counters up in interval A7,B4, so that total counter status is lsb=19.

In this case, the reason for the erroneous evaluation is that first pulse B1 of signal S1 arrives shortly before next signal A4 of the other signal S2, and overlapping periods (A5,B3 and A6,B4) are produced by a slight signal shift.

FIG. 11 shows an improved evaluation method, with which temporal overlaps of this type can be prevented. To this end, evaluation unit 4 checks to determine whether first pulse B1 of subsequently arriving ultrasonic signal S1 is located temporally closer to preceding pulse A3 or closer to subsequent pulse A4 of the other signal S2. A time threshold ts, which is located in the middle of interval A3,A4 in this case, serves as a reference standard in this case. Depending on the position of first reception time B1 of subsequently arriving ultrasonic signal S1 in the interval of first ultrasonic signal S2, first counter 5a counts the number of full intervals until first reception time B1, or one interval further. One of the following applies for the evaluation: Δt=Δtᵢ′+Δtᵢ″ (not shown, comparable, e.g., to FIG. 6), or Δt=Δt′−Δt′, where Δt′ would cover three intervals.

In the first case (pulse B1 is temporally before ts, not shown, comparable, e.g., with FIG. 8), first counter 5a counts the number of full intervals until first pulse B1 arrives. Subsequently, all subsequent pulses are interpreted in accordance with the order in which they arrive as pulse pairs Ai,Bi, the assigned time intervals [Ai,Bi] of which are measured by second counter 5b. In FIG. 8, A4,B2 is the first of these pulse pairs, for example. This method corresponds to the method shown in FIG. 8 or FIG. 10. The counter status of first counter 5a and second counter 5b are (after averaging) ultimately added or simply combined, with consideration for the different weights of the two counters.

In the second case (first pulse B1 arrives temporally after time threshold ts), first counter 5a counts one interval further, i.e., all full intervals [Ai,Ai+₁] up to and including interval [A₃,_{A}4] of signal S2, in which first pulse B1 of subsequent ultrasonic signal S1 falls. In this case, counter status hsb of first counter 5a therefore counts up to three. From this instant forward, all further pulses are combined into pairs Ai,Bi in the order in which they arrive. In FIG. 11, B2,A5 is the first of these pulse pairs. Second counter 5b again counts during a period of a pulse pair Ai,Bi, counter status counting up or down depending on the order of pulses Ai,Bi.

Pulse pairs in the order Bi,Ai are counted down, and pulse pairs in order Ai,Bi are counted up. Counter status lsb of second counter 5b is therefore initially negative (e.g., lsb=−2), the counts back to 0 during second interval A6,B3 and, during third interval A7,B4, it counts up by 2 counters, to, e.g., lsb=2. When the counter limits of second counter 5b are exceeded, first counter 5a receives a carry-over and therefore initially counts back to a counter status hsb=2 and then again to a counter status hsb=3.

FIG. 12 shows an exemplary embodiment of a control and evaluation circuit 4 that has nearly the same design as the evaluation circuit shown in FIG. 9. As was the case with FIGS. 7 and 9, neither the generation of ultrasonic signals S1,S2 from the clock pulse of a quartz oscillator nor the sequential control of the entire measurement procedure are shown, to ensure simplicity. Identical components are labelled with the same reference numerals.

In contrast to FIG. 9, module 6 of the evaluation circuit in FIG. 12 includes an additional “clock” clock input that makes it possible to perform an additional time measurement in order to decide whether first pulse Bi of subsequently arriving ultrasonic signal S1 arrives before or after time threshold ts sketched in FIG. 11. To measure time, a counter can be provided, for example, which can be integrated in module 6. The “enable” output of module 6 will therefore become active earlier or later, depending on the position of first reception time B1 of signal S1.

FIG. 13 shows an internal signal of evaluation circuit 4 that is switched from low to high when a reception event (e.g., a zero crossing) of a received ultrasonic signal S1, S2 is detected. The point in time of the rising signal flank has a certain temporal inaccuracy Δtᵢ due to signal jitter (signal jitters or noise).

FIG. 15 shows the jitter-induced frequency distribution of the detected point in time of the zero crossing in the case in which several measurements are carried out in succession. The standard deviation is indicated as ±Δtⱼ. The frequency distribution can correspond, e.g., to a normal distribution with the corresponding characteristic of a Gauss function.

The internal detection signal of FIG. 13 is typically sampled with a high-frequency clock pulse, as shown in FIG. 14 at the top. This clock pulse corresponds to the clock pulse at the clock input in FIGS. 9 and 12. When a clock pulse with a relatively low frequency f1 is selected, a relatively high aliasing error can result in the transit time measurement. In this case, the reception event is not detected by evaluation circuit 4 after a time Δtₐ. To prevent aliasing errors, it is provided to use a sampling signal with a frequency f2 (see FIG. 14, below) that is clearly higher than the reciprocal of the temporal inaccuracy (jitter) when individual reception events are detected. The accuracy of the measurement can be increased further via this oversampling, although the spread ±Δtⱼ of the frequency distribution of the input measured quantities per FIG. 15 remains just as great.

As a result of the methods for pulse evaluation described above, the measurement accuracy of an ultrasonic flow sensor can be improved substantially and, in particular, measuring errors can be prevented.

### LIST OF REFERENCE NUMERALS

1 Fluid
2 Direction of flow
3 Pipeline
4 Control and evaluation circuit
5a First counter
5b Second counter
6 Module for controlling the first counter
7 Module for controlling the second counter
8 Comparison gate
9 RS flip-flop
10 AND gate
11 Number of pulse pairs
12 Pulse pair counter
13 Counter status lsb
14 Counter status hsb
15 Ready output
16 Clock input
17 XOR gate
18 NOT gate
19 OR gate
20 Zero crossing signal
t1″ Reception time of initially arriving signal S2
tᵢ″ Reception times of subsequently arriving signal S1
Δt′ Rough estimate of transit time difference
Δtᵢ″ Time interval of a pulse pair
Δt Transit time difference
Ai Pulse of initially arriving signal S2
Bi Pulse of subsequently arriving signal S1

What is claimed is:

1. An ultrasonic flow sensor, particularly for measuring the volume flow or mass flow of a fluid (1) that flows through a pipeline (3) and includes two ultrasonic converters (A,B) that are offset in the direction of flow (2) and each transmit a periodic ultrasonic signal (S1,S2) to the other ultrasonic converter (B,A), and a control and evaluation unit (4) that detects several reception times (tᵢ′,tᵢ″) per ultrasonic signal (S1,S2) when an ultrasonic signal (S1,S2) is received by one of the ultrasonic converters (A,B), a measured quantity (S) being determined from one of the reception times (tᵢ′,tᵢ″),
wherein
the control and evaluation circuit (4) includes at least two counters (5a, 5b), the first counter (5a) counting the full intervals ([tᵢ′,tᵢ₊₁′]) of a first signal (S2,P) at least until the first reception time (t₂″) of an ultrasonic signal (S1), and the second counter (5b) determining a time interval (Δt″) between a first switchover/reception time (A4) and a second switchover/reception time (B2) of the signals (S1,S2,P) out of several paired switchover/reception times (tᵢ′,tᵢ″).

2. The ultrasonic flow sensor as recited in claim 1,
wherein,
in a first operating mode, the first signal (S2,P) is an ultrasonic signal (S2) that is sent out simultaneously with the other ultrasonic signal (S1), or, in a second operating mode, it is a reference signal (P) that is generated out of the same clock pulse as the ultrasonic signal (S1).

3. The ultrasonic flow sensor as recited in claim 1,
wherein
each of the paired reception times (tᵢ′, tᵢ″) includes a switchover/reception time (Ai) of the signal (S2,P) and a subsequent reception time (Bi) of the ultrasonic signal (S1).

4. The ultrasonic flow sensor as recited in claim 1,
wherein
the control and evaluation circuit (4) checks to determine whether the first reception time (tᵢ″) of the ultrasonic signal (S1) is temporally closer to the preceding (t₃′) or subsequent switchover/reception time (t₄′) of the signal (S2,P) than a specified time threshold (t0), whereby, in the first case, the first counter (5a) counts the period (Δt′) from the first switchover/reception time (t₁′) until the switchover/reception time (t₃′) of the signal (S2,P) that precedes the reception time (t₁″) of the ultrasonic signal (S1) and, in the other case, it counts until the switchover/reception time (t₄′) that follows the first reception time (t₁″) of the ultrasonic signal (S1).

5. The ultrasonic flow sensor as recited in claim 1,
wherein
the second counter (5b) is an up-down counter that counts either up or down, depending on a series of paired reception times (tᵢ′,tᵢ″) or (tᵢ″,tᵢ′).

6. The ultrasonic flow sensor as recited in claim 5,
wherein
the first counter (5a) is an up-down counter that can receive a positive or a negative carry-over from the second counter (5b).

7. The ultrasonic flow sensor as recited in claim 1,
wherein
the second counter accumulates the period (Δt″) of the intervals defined by p pairs of reception times (tᵢ′,tᵢ″), p being a square number.

8. The ultrasonic flow sensor as recited in claim 7,
wherein,
after the period defined by p pairs of intervals is measured, the counter status of the second counter (5b) is averaged by performing a shift register operation, by eliminating binary places, or via a modified interpretation of the weight of the binary places.

9. A method for determining the transit time difference (Δt) between two ultrasonic signals (S1, S2) from an ultrasonic flow sensor with two ultrasonic converters (A,B) that are offset in the direction of flow (2) and each transmit an ultrasonic signal (S1,S2) to the other ultrasonic converter (B,A), and a control and evaluation circuit (4) that detects several reception times (tᵢ′,tᵢ″) per ultrasonic signal (S1,S2) when an ultrasonic signal (S1,S2) is received by one of the ultrasonic converters (A,B), a measured quantity (S) being determined from one of the reception times (tᵢ′,tᵢ″),
wherein,
using a first counter (5a), a period (Δt′) of the full intervals ([tᵢ′,tᵢ₊₁′]) of a signal (S2,P) is counted at least until the first reception time (t₂″) of an ultrasonic signal (S1), and, using a second counter (5b), the time intervals (Δt″) between a first reception time and a second reception time out of several pairs reception times (tᵢ′,tᵢ″) being determined.

10. The method as recited in claim 9,
wherein
the second counter (5b) measures the periods (Δtᵢ″) between several paired instants (tᵢ′, tᵢ″), each of which includes a switchover/reception time (tᵢ′) of the signal (S2,P) and a reception time (tᵢ″) of the ultrasonic signal (S1).

11. The method as recited in claim 9,
wherein,
a check is carried out to determine whether the first reception time (t₁″) of the ultrasonic signal (S1) is temporally closer to the preceding (t₃′) or subsequent switchover/reception time (t₄′) of the signal (S2,P) than a specified time threshold (t0) whereby, in the first case, the first counter (5a) counts the period (Δt′) from the first switchover/reception time (t₁′) until the switchover/reception time (t₃′) of the signal (S2,P) that precedes the reception time (t₁″) of the ultrasonic signal (S1) and, in the other case, it counts until the switchover/reception time (t₄′) that follows the first reception time (t₁″) of the ultrasonic signal (S1).

12. The method as recited in claim 9,
wherein
a digital signal from the evaluation circuit (4) that displays the receipt of a reception event (Ai, Bi) is sampled with a sampling signal, the frequency of which is markedly higher than the reciprocal of the temporal inaccuracy (Δtⱼ) of the signal (20).
